(19) United States
(12) Patent Application Publication
(10) Pub. No.: US 2020/0396207 A1
(43) Pub. Date: Dec. 17, 2020

(54) PERMITTING FIREWALL TRAFFIC AS EXCEPTIONS IN DEFAULT TRAFFIC DENIAL ENVIRONMENTS

(71) Applicant: Microsoft Technology Licensing, LLC, Redmond, WA (US)

(72) Inventors: Girish M. MOTWANI, Sunnyvale, CA (US); Yair TOR, Sammamish, WA (US); Sinead C. O'DONOVAN, Redmond, WA (US); Murali K. SANGUBHATLA, Sunnyvale, CA (US); Andrey TERENTYEV, Sunnyvale, CA (US); Madhusudhan RAVI, Sunnyvale, CA (US)

(21) Appl. No.: 16/443,487

(22) Filed: Jun. 17, 2019

(51) Int. Cl. H04L 29/06; G06K 9/62; G06F 11/34

(52) U.S. Cl. CPC H04L 63/0263; G06F 11/3476; G06K 9/6262

(57) ABSTRACT

A solution for firewall auto-learning in in zero trust environments, such as cloud environments, includes: based at least on a first trigger event, determining a first set of restricted dependencies for a cloud service firewall to learn for a first application; during a first learning phase, learning a first set of candidate rules corresponding to at least a portion of the first set of restricted dependencies; receiving an indication of verifying, blocking, or tailoring one or more candidate rules within the first set of candidate rules, to generate a first set of verified rules; and operating the firewall with the first set of verified rules for the first application. Some examples include receiving a set of constraints, such as a selection from a set of preset constraints and/or a custom constraint. Some examples include retraining based at least on a second trigger event and/or learning rules for a second application.

### BACKGROUND

Firewalls are critical components for securing internet-connected computing resources, such as application software (“applications”). However, the potential security performance of a firewall cannot be achieved if it is not properly configured with rules identifying permitted and/or denied connections with external nodes or services. In cloud environments, when a user is attempting to configure a firewall to protect virtual network or on-premises (“on-prem”) resources, identifying the necessary information for configuration can be challenging and time-consuming. Additionally, this information may be deployment specific and even change over time, make it harder for users to determine alone the right set of access rules.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Some aspects disclosed herein are directed to a solution for firewall auto-learning in zero trust environments, such as cloud environments. Examples include, based at least on a first trigger event, determining a first set of restricted dependencies for a cloud service firewall to learn for a first application; during a first learning phase, learning a first set of candidate rules corresponding to at least a portion of the first set of restricted dependencies; receiving an indication of verifying, blocking, or tailoring one or more candidate rules within the first set of candidate rules, to generate a first set of verified rules; and operating the firewall with the first set of verified rules for the first application. Some examples include receiving a set of constraints, such as a selection from a set of preset constraints and/or a custom constraint. Some examples include retraining based at least on a second trigger event and/or learning rules for a second application.

### BRIEF DESCRIPTION OF THE DRAWINGS

The disclosed examples are described in detail below with reference to the accompanying drawing figures listed below:

FIG. 1 illustrates an exemplary arrangement that advantageously employs firewall auto-learning in zero trust environments;

FIG. 2A illustrates an exemplary configuration interface for controlling firewall auto-learning in zero trust environments;

FIG. 2B illustrates the interface of FIG. 2A but with another feature selected;

FIG. 3A illustrates another exemplary configuration interface for controlling firewall auto-learning in zero trust environments;

FIG. 3B illustrates the interface of FIG. 3A but with another feature selected;

FIG. 4 illustrates another exemplary configuration interface for controlling firewall auto-learning in zero trust environments;

FIG. 5 is a timeline of exemplary operations involved in firewall auto-learning in zero trust environments;

FIG. 6 is a flow chart illustrating exemplary operations involved in firewall auto-learning in zero trust environments; and

FIG. 7 is a block diagram of an example computing environment suitable for implementing some of the various examples disclosed herein.

Corresponding reference characters indicate corresponding parts throughout the drawings.

### DETAILED DESCRIPTION

The various examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Platform as a Service (PaaS) or Application Platform as a Service (aPaaS) or platform-based service is a category of cloud computing services that provides a platform allowing users to develop, run, and manage applications without the complexity of building and maintaining for themselves the entirety of the infrastructure typically associated with developing and launching an application.

Firewalls are critical components for securing internet-connected computing resources, such as application software (“applications”). In some implementations, firewalls deny traffic by default, unless a rule permits the traffic. In a zero-trust environment, all traffic is denied by default. With this approach, the user is presented with the challenge of determining what traffic should be allowed. When the allow rules are too permissive, the need to specifically deny some traffic becomes relevant (e.g., denying a subset of traffic that is allowed by some rules). The potential security performance of a firewall cannot be achieved if it is not properly configured with rules identifying permitted and/or denied connections with external nodes or services. Unfortunately, when a user is attempting to configure a firewall to protect virtual network or on-prem resources, identifying the necessary information for configuration can be challenging and time-consuming. This is because dependencies are often deployment-specific, and can change for a given application due to an update. Additionally, home grown applications that are moved to the cloud, have their own access needs, but users are rarely aware of them. One potential solution is the use of a learning phase during early stages of an application deployment. This introduces a problematic scenario: Undesirable network traffic (e.g., data exfiltration) could occur during the learning phase and therefore could be included within the firewall configuration, thereby reducing the effectiveness of the firewall.

Therefore, a disclosed solution for firewall auto-learning is presented for zero trust environments, such as cloud environments. The user reviews the learned rules and can either remove them (equal to deny by default), modify them, or accept them. When the list of rules (“rule collection”) is ready, the user assigns a priority and action to the collection and deploys it. In some examples, this includes: based at least on a first trigger event, determining a first set of restricted dependencies for a cloud service firewall to learn for a first application; during a first learning phase, learning a first set of candidate rules corresponding to at least a portion of the first set of restricted dependencies; receiving an indication of verifying, blocking, or tailoring one or more candidate rules within the first set of candidate rules, to generate a first set of verified rules; and operating the firewall with the first set of verified rules for the first application. Some examples include receiving a set of constraints, such as a selection from a set of preset constraints and/or a custom constraint. Some examples include retraining based at least on a second trigger event and/or learning rules for a second application.

Aspects of the disclosure operate in an unconventional way to improve firewall auto-learning in zero trust environments by guiding and restricting learning. That is, application dependencies are learned within constraints, such as preset constraints and/or custom user-defined constraints. By restricting learning, unlearned network traffic will continue to be blocked by the firewall. Various learning modes include learn and allow and learn and deny. In some examples, known storage solutions and other services are made available with preset constraints managed (and updated) by a service provider, to ease the burden on users.

Aspects of the disclosure teach automatically learning dependencies for traffic that is flowing through a firewall and allowing users to create access rules based on that learning. The learning is restricted by a set of constraints, so that the firewall can only learn the needed access for specific destinations. For example, users may configure the firewall to learn access to only certain storage and services and avoid unwanted learning. The learning process is configurable to last hours to days, and at the end the user is presented with a suggested set of rules that are required for a given application. The user reviews and edits the rules before activating them. Using this approach, moving applications to a hosted cloud service (a.k.a. “lift and shift”) is sped up, while still enabling users to secure egress traffic and avoid data exfiltration.

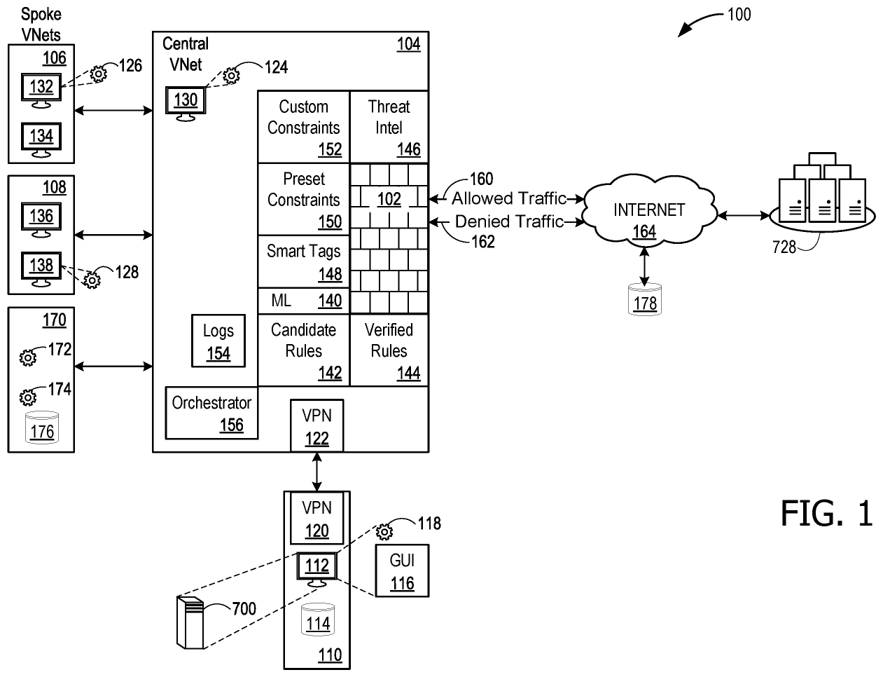

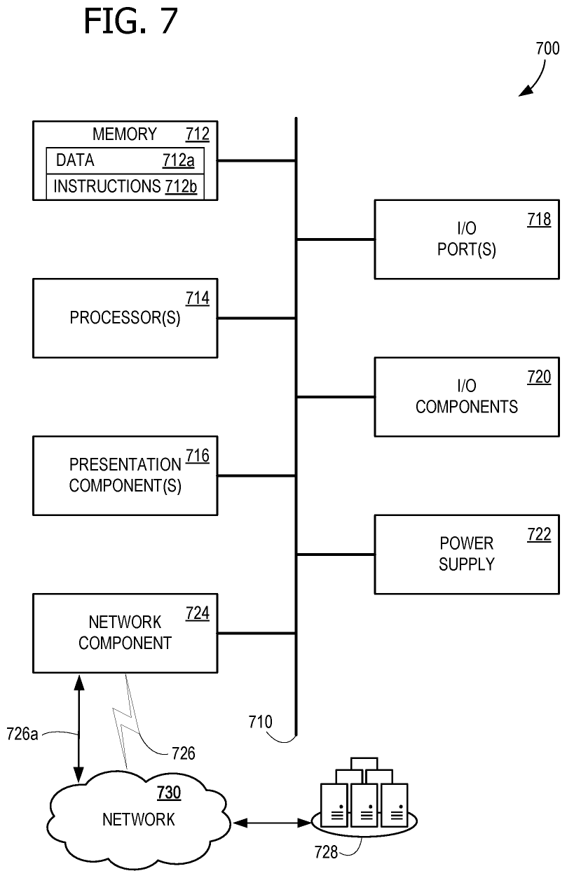

FIG. 1 illustrates an exemplary arrangement 100 that advantageously employs firewall auto-learning in zero trust environments. In some examples, at least some of the hardware components for arrangement 100 are provided by one or more computing devices 700 of FIG. 7. A cloud service firewall 102 operates in a central virtual network (VNet) 104 in a cloud service and includes spoke VNets 106 and 108. VNet 104 hosts a virtual machine (VM) 130, and VNets 106 and 108 host VMs 132, 134, 136, and 138, as shown. The user has its on-premises network 110 with a local computing node 112 and a local data store 114. A virtual private network (VPN) connection point 120 at on-premises network 110 provides secure communication with VPN connection point 122 at VNet 104. It should be understood that a different arrangement and number of VNets, VMs, and VPNs can be used, in some examples.

The user has deployed a first application 124 on VM 130, a second application 126 on VM 132, and a third application 128 on VM 138. At some point, the user will update first application 124 with application update 118 (via VPN connection points 120 and 122). Application update 118 is illustrated as residing within on-premises network 110, although it could be located elsewhere, such as on a cloud resource 728. Unfortunately, the user may possess less information about the dependencies of application 124 (and the others) when application 124 is running in a cloud environment (e.g., one of VNets 104, 106, and 108), than if the user was hosting application 124 solely within its own on-premises network 110. As a result, the user may require assistance with properly configuring firewall 102.

Although the service provider, who provides VNet 104, does know information about VNets 104, 106, and 108 and an associated services set 170 (because these are managed and/or provided by the service provider), firewall 120 is a service for which the configuration is owned by the user (customer). Thus, the learning is designed to make it easier for the user to set and manage the configuration of firewall 102. As illustrated, associated services set 170 includes application services 172 and 174 and also the service provider's cloud storage service 176. However, the service provider is unlikely to know all of the dependencies for third party applications, such as application 124, if it was designed and/or produced by the user or another software developer. This is because application dependencies might be deployment-specific, such as some PAAS services and some home-grown applications. As a result, the service provider who operates VNet 104 that runs firewall 102 is able to assist with configuring firewall 102 for dependencies of application 124 related to application services 172 and 174 and also cloud storage service 176. However, in general the service provider's knowledge does not extend to external cloud storage service 178 or communication with cloud resource 728 or other nodes across internet 164.

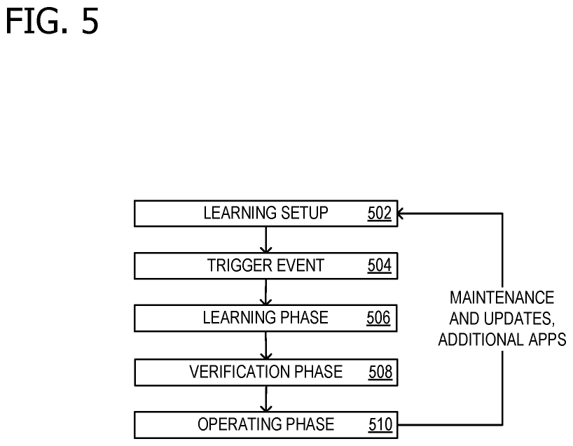

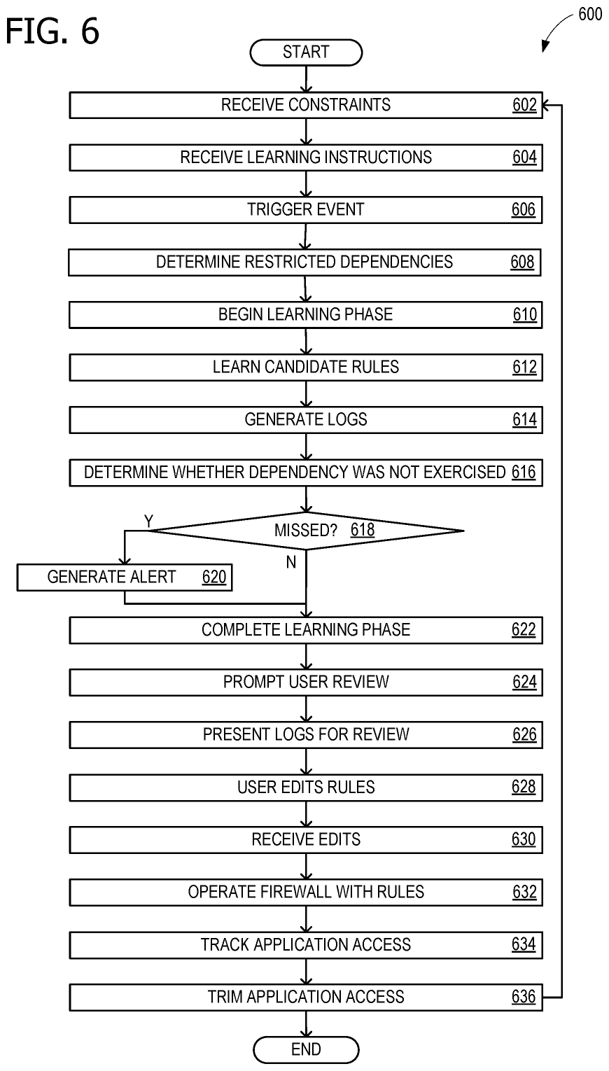

Thus, firewall 102 requires custom configuration of rules in order for application 124 to operate properly. The various phases of the configuration process, managed by an orchestrator 156, are described in more detail with respect to a timeline 500 and a flow chart 600 in FIGS. 5 and 6, respectively. One item of concern for the user is that, although the service provider endeavors to operate VNets 104, 106, and 108 securely, from the user's perspective, VNets 104, 106, and 108 are zero trust environments. This is because users are often concerned about data exfiltration for reasons that are independent of the provider of VNets 102-108. For example, the user's organization may have malicious insiders or other risk factors for a data theft incident which are to be proactively addressed by firewall 102. The user may thus be concerned that unrestricted learning could introduce undesirable rules into the configuration of firewall 102. Thus, firewall 102 is trained with restricted learning by an ML component 140. A preview of an exemplary process (described in more detail with respect to FIGS. 5 and 6) is that ML component 140 learns with candidate rules 142 during a learning phase, and the user the verifies, blocks (rejects), or tailors various ones of candidate rules 142 to produce verified rules 144. Then, in normal operations, firewall 102 uses verified rules 144 and threat intelligence (intel) 146, which may be provided by the service provider of VNet 104 and/or other security sources, to manage traffic for application 124. Threat intel-based filtering enables firewall 102 to alert and deny traffic from/to known malicious IP addresses and domains.

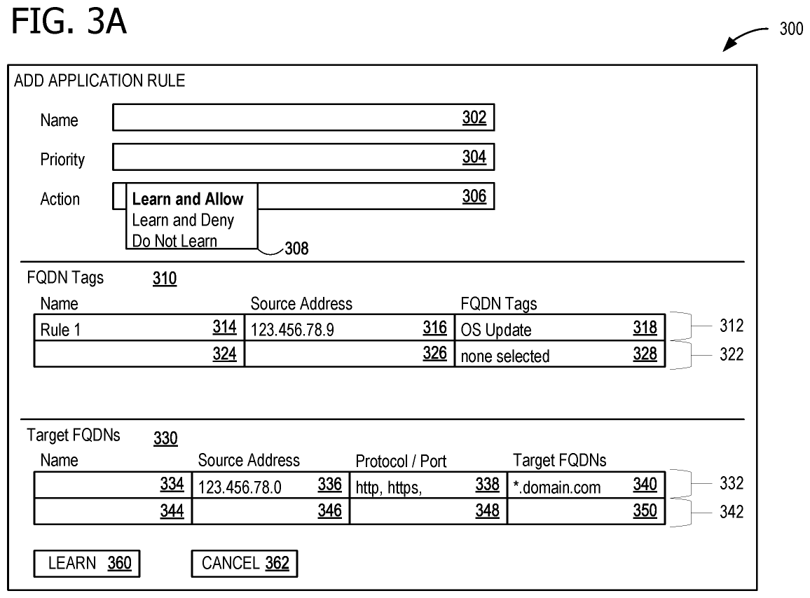

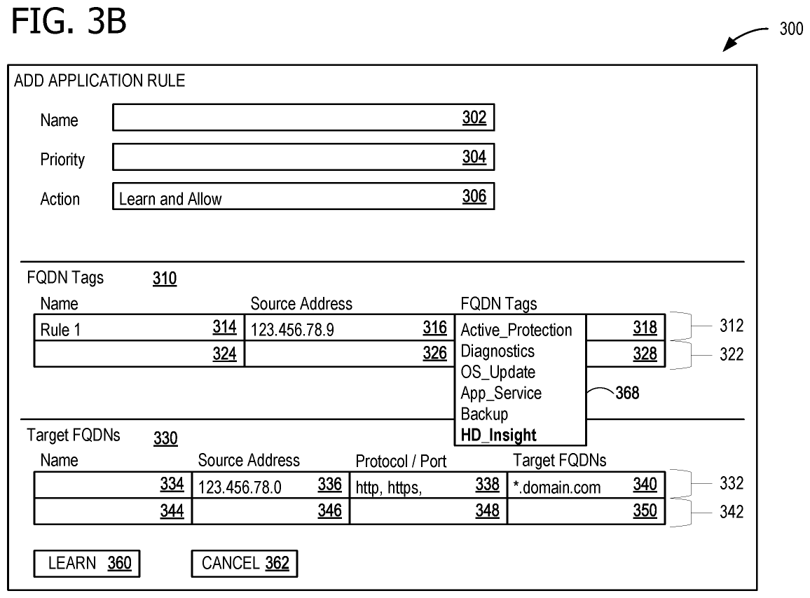

For example, firewall 102 permits egress for traffic 160 from application 124 and blocks egress traffic 162 from application 124. For private applications (e.g. spoke to spoke communication among VNets 106 and 108) firewall 102 permits or denies traffic incoming to or outgoing from application 126 or 128. Although allowed traffic 160 and denied traffic 162 are illustrated as going to and from internet 164, firewall 102 also manages traffic going to and from associated services set 170 and among VNets 104, 106 and 108. Associated services set 170 can be in various locations, including, in some examples, across internet 164. Associated services set 170 includes storage, operating system (OS) updates, diagnostics, and other services (see, for example FIG. 3A).

Prior to the start of the learning phase, in some examples, the user uses a graphical user interface (GUI) 116 to set up restricted dependencies that can include smart tags 148, which are a portion of preset constraints 150, and also custom constraints 152. In some examples, a command line interface or script is used. Smart tags 148 includes a set of fully qualified domain names (FQDNs), which can include wild cards, for services known to be secure. Examples include some OS update services and some storage services, for example within associated services set 170. Smart tags 148, and other preset constraints 150, allow the user to rapidly build a set of restricted dependencies for firewall 102 to learn for application 124, and also other applications 126 and 128, along with relearning when application 124 is updated with application update 118. Users can limit outbound http/s traffic to a specified list of FQDNs, including wild cards. Other protocols can also be used. This permits rapidly creating rules for network filtering to allow or deny traffic based on source and destination interne protocol (IP) address, port, and protocol. In some examples, at least two types of dependencies are learned: (1) target FQDN and target URLs, which is Layer 7 learning; and (2) target IPs, which is Layer 4 learning (in the TCP/IP 7 layer model). In some examples, the user can select tags, but not edit them.

Rules are enforced and logged across multiple subscriptions and VNets. For example, with an FQDN tag for an OS update, network traffic from a verified OS update network address can flow through firewall 102. A service tag represents a group of IP address prefixes to help minimize complexity for security rule creation. In some examples, the service provider manages the address prefixes encompassed by the service tag, and automatically updates the service tag as addresses change. In some examples, a preset rule collection includes access to a storage platform image repository (PIR), managed disks status storage access, diagnostics and logging, overriding, and others. Users can override the presets by creating a deny all application rule collection that is processed last.

During the learning phase, logs 154 are generated from learning candidate rules 142. Logs 154 are presented to the user, for example via GUI 116, so that the user can intelligently verify, block, or tailor one or more of candidate rules 142, based on evaluating logs 154. That is, the user reviews the learned rules and can either remove them (equal to deny by default), modify them, or accept them. In operation, orchestrator 156 receives a set of constraints for a first set of restricted dependencies (e.g., custom constraints 152 and preset constraints 150, which includes smart tags 148), such as from the user via GUI 116. In some examples, receiving a set of constraints for the first set of restricted dependencies comprises receiving at least one input selected from the list consisting of: a selection from preset constraints 150 and custom constraints 152. In some examples, the first set of restricted dependencies comprises at least one dependency selected from the list consisting of: an application dependency and a network dependency. Application rules are Layer 7 constructs and network rules are Layer 4 constructs learning in the TCP/IP 7 layer model. An application dependency is a necessary communication (for proper operation) with an application service, such as application services 172 and 174, whereas a network dependency is a necessary communication across a network, such as internet 164. In some examples, orchestrator 156 receives instructions (via GUI 116) for candidate rules 142 to learn and deny or to learn and allow.

Based at least on a first trigger event, ML component 140 determines a first set of restricted dependencies for firewall 102 to learn for application 124. In some examples, the first trigger event comprises an event selected from the list consisting of: a user input (via GUI 116) and an update to application 124, as sensed by orchestrator 156. During a first learning phase, ML component 140 learns set of candidate rules 142 corresponding to at least a portion of the first set of restricted dependencies. Also, during the first learning phase, in some examples, orchestrator 156 generates logs from learning candidate rules 142. In some examples, orchestrator 156 also determines whether, from among the first set of restricted dependencies, a dependency was not exercised. This situation prevents ML component 140 from learning the associated rule. Thus, in some examples, based at least on determining that a dependency was not exercised, orchestrator 156 generates an alert for the user (such as through GUI 116) identifying that a dependency was not exercised.

At the completion of the first learning phase, or in some examples, during the first learning phase, orchestrator 156 presents logs 154 to the user for evaluation. Orchestrator 156 receives, from the user an indication of verifying, blocking, or tailoring one or more candidate rules within candidate rules 142, to generate verified rules 144. VNet 104 then operates firewall 102 with verified rules 144 for application 124. Additionally, firewall 102 can be trained (e.g., configured via learning by ML component 140) for one or more of applications 126 and 128 in a second learning phase. In some examples, training and rule sets are specific to a particular application (e.g., are unique to a single application and each application has its own verified rules 144). In some examples, training can be conducted in parallel, and/or rule sets can apply to more than just a single application. In some examples, the trigger event for learning includes the user completing entry of restricted dependency information into GUI 116.

In some examples, the trigger event for learning includes orchestrator 156 identifying a situation in which updating or retraining dependencies for a particular application is warranted, such as when smart tags are updated. For situations in which application 124 is updated with application update 118, some security paradigms indicate that user-initiated retraining is preferable over automatic retraining. In some examples, when traffic that does not match learned rule set triggers an alert for unexpected traffic within a short time period, retraining may be warranted. In an exemplary scenario, the initial learning phase is set to 24 hours, and the user can indicate that retraining will be permitted (possibly automatically) if alert for unexpected traffic occurs within a week of the completion of the initial learning phase. The retraining may then cover dependencies that were not properly discovered (learned) initially. In some scenarios, if retraining is allowed for a longer time period, a data exfiltration attempt might be mistaken as a need for retraining. In another exemplary scenario, retraining is tied to the use of smart tags. The provider of VNet 104 knows that a smart tag requires updating and the user has agreed for that automatic training is permissible under the user's defined restrictions, based upon the provider's recommendation. For example, a PaaS service in a VNet may need an additional dependency to storage account. In such scenarios, the retraining can be limited to learning only new storage access (and not other access).

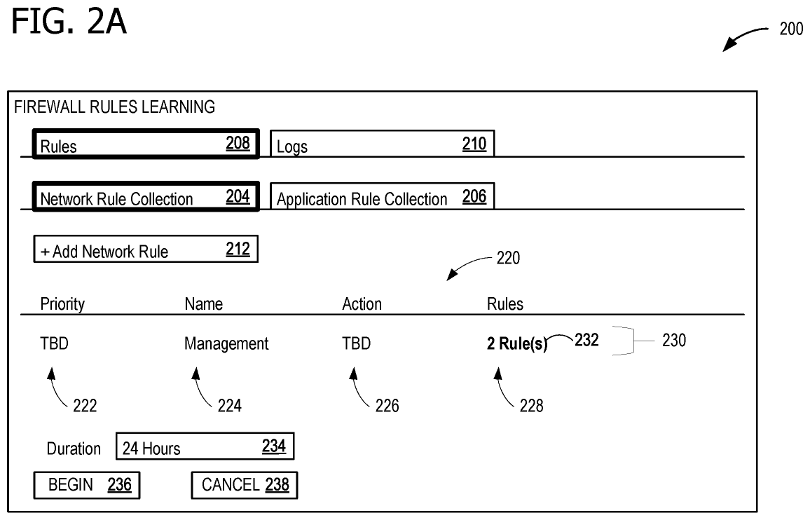

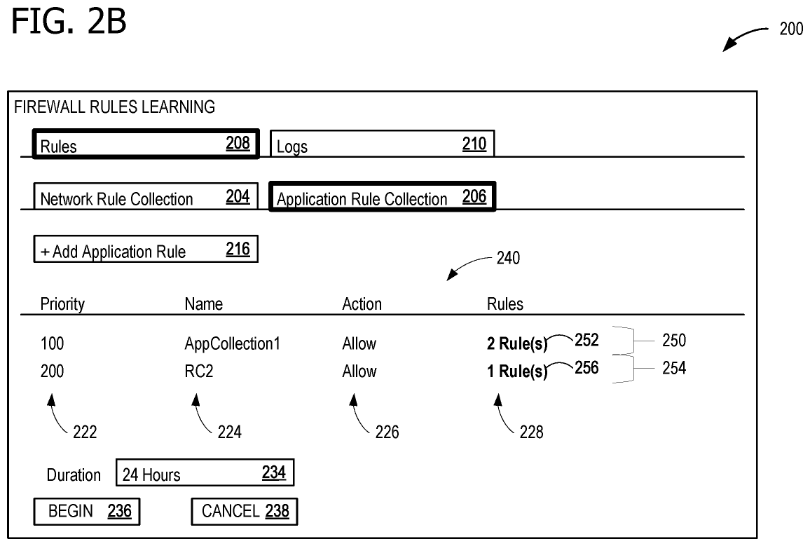

FIG. 2A illustrates an exemplary configuration interface 200 for controlling firewall auto-learning in zero trust environments. Configuration interface 200 is one of the screens presented by GUI 116. Two specific rule tabs, network rule tab 204 and application rule tab 206, are visible under primary rules tab 208. As indicated, there is also a logs tab 210, which is selectable in order to display logs 154. As illustrated, both primary rules tab 208 and network rule tab 204 are selected. An “Add Network Rule” GUI button 212 permits the user to add further network rules to learn. A rules display area 220 has five columns in a table style display: priority 222, name 224, action 226, and rules count 228. A single table entry 230 indicates two network rules in a selectable link 232. During the learning setup phase, the user can select to allow the traffic during learning or deny it. When the learning phase is completed and the rules are reviewed, the user can assign the priority and action (which will be shown in the columns priority 222 and action 226) and save the configuration, as if the rule collection had been manually entered.

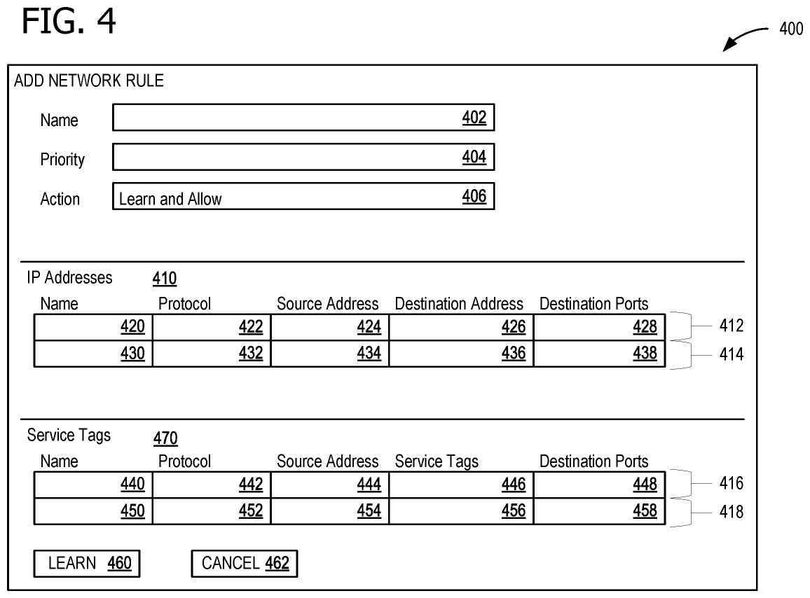

A user clicking on selectable link 232 moves GUI 116 to display a new page (screen) listing the specific rules referenced by table entry 230, for example configuration interface 400 FIG. 4.

A duration field 234 permits the user to specify the duration of the learning phase. A begin GUI button 236 can act as a trigger event to initiate a learning phase, and a cancel GUI button 236 permits the user to exit GUI 116 without initiating a learning phase.

FIG. 2B illustrates interface 200 with another feature selected, specifically application rule tab 206. An “Add Application Rule” GUI button 216 permits the user to add further application rules to learn. In some examples, GUI 116 is shared for manual configuration of rules and viewing of a rule collection that was learned (candidate rules 142) and operated (verified rules 144). When using GUI 116 for learning, the user defines the source IPs/IP ranges to learn, the duration, constraints, and whether to learn and allow or learn and deny. This is less effort than manual configuration from scratch. Two sets are produced: network and application rules for the user to review.

A rules display area 240 has five columns 222, 224, 226, and 223, in a table style display. A first table entry 250 indicates two application rules in a selectable link 252. A user clicking on selectable link 252 moves GUI 116 to display a new page listing the specific rules referenced by table entry 250. A second table entry 254 indicates one application rule in a selectable link 256. A user clicking on selectable link 256 moves GUI 116 to display a new page listing the specific rule referenced by table entry 254. In some examples, the different priorities assigned to different rules have no practical effect, since the rules are enforced independently of priority. A user clicking on “Add Application Rule” GUI button 216 takes GUI 116 to configuration interface 300, illustrated in FIGS. 3A and 3B.

FIG. 3A illustrates an exemplary configuration interface 300 for controlling firewall auto-learning in zero trust environments. Configuration interface 300 is one of the screens presented by GUI 116. Configuration interface 300 includes a name field 302, a priority field 304, an action field 306, an FQDN area 310, and a target FQDNs area 330, along with a learn GUI button 360 and a cancel GUI button 362. Upon completing data entry into configuration interface 300, the user clicking on learn GUI button 360 makes the restricted dependencies entered into configuration interface 300 available for rules learning by ML component 140. Cancel GUI button 362 ignores any recent changes input into configuration interface 300. Action field 306 shows a drop-down menu 308 indicating various learning options, “Learn and Allow” and “Learn and Deny.” Drop-down menu 308 also includes a “Do not Learn” option that proactively restricts certain learning.

FQDN area 310 permits rapid entry of smart tag information, leveraging management of FQDN tag specifics by a service provider who has access to the necessary data, such as the service provider providing VNet 104 and/or associated services set 170. FQDN area 310 includes data entry fields for two rule constraint sets 312 and 322. These include name fields 314 and 324, source address fields 316 and 326, and FQDN tag fields 318 and 322. As indicated, FQDN tag field 318 uses a preset constraint identifying an application service (e.g., application service 172) for OS_Update. This is a smart tag, and the details are managed for the user by the service provider, easing the burden on the user.

Learning includes target FQDNs and target IP addresses. When learning can determine that a set of dependencies is actually a service tag or FQDN tag, this is indicated in FQDNs area 330. Dependency information includes desired protocol and domain names, such as URLs with wildcards. In some examples, there is no need to define target FQDNs as this information is learned. FQDN tags (smart tags) are a way to deliver constraints with a tag. The content of a tag can indeed be used as a constraints list, which is narrowed based on actual access. For example, a tag may include “*.blob.core.provider.net” which means allow access to a wide range of storage locations. After learning, this is replaced with a specific FQDN for a storage account such as “myaccount.blob.core.provider.net.”

Target FQDNs area 330 includes name fields 334 and 334, source address fields 336 and 336, protocol/port fields 338 and 348, and target FQDNs fields 340 and 350. FQDN area 310 indicates an example of learning setup using smart tags 148. FQDN area 310 and target FQDNs area 330 indicate examples of learning setup using preset constraints 150.

FIG. 3B illustrates interface 300 with another feature selected, specifically a drop-down menu 368 in FQDN tag field 318. Drop-down menu 368 indicates a plurality of FQDN tag options (smart tags) that have been managed and preset for the convenience of the user. These include protection, diagnostics, OS update, application service, backup, and HDInsight (Hadoop components) services. HDInsight facilitates process large amounts of data.

FIG. 4 illustrates an exemplary configuration interface 400 for controlling firewall auto-learning in zero trust environments. Configuration interface 400 is one of the screens presented by GUI 116. Similarly, to configuration interface 300, configuration interface 400 includes a name field 402, a priority field 404, an action field 406, a learn GUI button 460, and a cancel GUI button 462. Upon completing data entry into configuration interface 400, the user clicking on learn GUI button 460 makes the restricted dependencies entered into configuration interface 400 available for rules learning by ML component 140. Cancel GUI button 462 ignores any recent changes input into configuration interface 400. Action field 406 accepts input such “Learn and Allow” and “Learn and Deny.” Configuration interface 400 also includes an IP address area 410, and a service tags area 470. IP address area 410 indicates an example of learning setup using custom constraints 152.

IP address area 410 includes data entry fields for two rule constraint sets 412 and 414. These include name fields 420 and 430, protocol fields 422 and 432, source address fields 424 and 434, destination address fields 426 and 436, and destination ports 428 and 438. Service tags area 470 includes data that, in some examples, is managed by the provider of VNet 104. This include name fields 440 and 450, protocol fields 442 and 452, source address fields 444 and 454, service tags fields 446 and 456, and destination ports 448 and 458.

FIG. 5 is a timeline 500 illustrating exemplary operations involved in firewall auto-learning in zero trust environments. Timeline 500 commences with phase 502 for learning setup, for example, via GUI 116. In some examples, phase 502 includes receiving a set of constraints for a set of restricted dependencies. In some examples, receiving a set of constraints for the set of restricted dependencies includes receiving a selection from a set of preset constraints and/or a custom constraint. In some examples, the set of restricted dependencies includes an application dependency and/or a network dependency. In some examples, phase 502 includes receiving instructions for a set of candidate rules to learn and deny or to learn and allow.

A trigger event occurs in phase 504, to initiate a learning phase 506. In some examples, a trigger event is based on user input. In some examples, a trigger event is based on an update to an application, or another indication that the application is not performing properly because some needed dependencies are being blocked. Based at least on the trigger event, learning phase 506 is initiated, and includes determining a set of restricted dependencies for a cloud service firewall to learn for an application. During learning phase 506, a set of candidate rules is learned that corresponds to at least a portion of the set of restricted dependencies. In some examples, during the first learning phase, logs are generated from learning the set of candidate rules. Some examples include determining whether, from among the set of restricted dependencies, one or more dependencies were not exercised. Based at least on determining that a dependency was not exercised, either during learning phase 506 or during a following verification phase 508, an alert is generated identifying that a dependency was not exercised. In some examples the learning phase is 24 hours. In some examples, the learning phase is a different duration, such as 48 hours, a week, or some other duration. During learning phase 506, the user should try to flex the application to exercise all capabilities and dependencies. If the user did not use certain functionality, then training might not have the proper scope.

During the verification phase 508, prior to receiving an indication of verifying, blocking, or tailoring one or more candidate rules, the logs are presented to a user (or some other artificial intelligence (AI) component) for evaluation. The candidate rules are assessed for verifying, blocking, or tailoring one or more candidate rules within the set of candidate rules, to generate a set of verified rules. After verification of the rules, during operating phase 510, the firewall is operated with the set of verified rules for the application, and in some examples, also with threat intel, which blocks some traffic, such as traffic associated with malicious logic and activity (e.g., unauthorized data exfiltration). Timeline 500 is cyclical, so that phases 502 through 510 are repeated for maintenance and updates to the application, and also for additional applications (apps).

FIG. 6 is a flow chart 600 illustrating exemplary operations involved in firewall auto-learning in zero trust environments. In some examples, operations described for flow chart 600 are performed by computing device 700 of FIG. 7, and operations in flow chart 600 correspond with portions of the phases on timeline 500. Flow chart 600 commences with operation 602, which includes receiving a set of constraints for a set of restricted dependencies. In some examples, receiving a set of constraints for the set of restricted dependencies comprises receiving at least one input selected from the list consisting of: a selection from a set of preset constraints and a custom constraint. In some examples, the set of restricted dependencies comprises at least one dependency selected from the list consisting of: an application dependency and a network dependency. Operation 604 includes receiving instructions for a set of candidate rules to learn and deny or to learn and allow. In some examples operation 604 also includes receiving “Do Not Learn” instructions. Operation 606 includes detecting a trigger event, such as user input or a sensed condition for an application that indicates a need for another learning cycle. In some examples, the trigger event comprises an event selected from the list consisting of a user input and an update to the first application.

Operation 608 includes, based at least on a trigger event, determining a set of restricted dependencies for a cloud service firewall to learn for a first application. Operation 610 begins a learning phase, which may be 24 hours, 48 hours, or some other duration specified by the user or an algorithm. Operation 612 includes, during a learning phase, learning a set of candidate rules corresponding to at least a portion of the set of restricted dependencies. Operation 614 includes, during the learning phase, generating logs from learning the set of candidate rules. Operation 616 includes determining whether, from among the set of restricted dependencies, a dependency was not exercised. This can occur if the application was not sufficiently flexed or stressed during the learning phase.

If, in decision operation 618, it is determined that a dependency was not exercised, then operation 620 includes based at least on determining that a dependency was not exercised, generating an alert identifying that a dependency was not exercised. Operation 622 is the completion of the learning phase, such as the learning phase reaching its specified duration or some other criteria. In some examples, operation 620 occurs after the learning phase is completed (e.g., after operation 622). In operation 624, the user is prompted to review the rules, for example to change them from learn to allow or deny. This involves operation 626, which includes, prior to receiving an indication of verifying, blocking, or tailoring one or more candidate rules, presenting the logs for evaluation.

The user edits the rules by verifying, blocking, or tailoring various candidate rules to produce verified rules in operation 628. Thus, operation 630 includes receiving an indication of verifying, blocking, or tailoring one or more candidate rules within the set of candidate rules, to generate a set of verified rules. Operation 632 includes operating the firewall with the set of verified rules for the first application. In some examples, operation 630 also includes using threat intel to block (deny) certain traffic.

Operation 634 includes tracking application access events (via the logs) to determine whether the application is using the full scope of permitted traffic. Operation 636 includes, based at least on determining that the application is not using the full scope of permitted traffic, trimming the scope of permitted traffic. In some examples, this is implemented by trimming permitted traffic to that traffic which is within the logs and is not associated with potential problems. Flow chart 600 repeats as necessary for a second trigger event for the application, and/or for additional applications.

### Additional Examples

Some aspects and examples disclosed herein are directed to a system for firewall auto-learning comprising: a processor; and a computer-readable medium storing instructions that are operative when executed by the processor to: based at least on a first trigger event, determine a first set of restricted dependencies for a cloud service firewall to learn for a first application; during a first learning phase, learn a first set of candidate rules corresponding to at least a portion of the first set of restricted dependencies; receive an indication of verifying, blocking, or tailoring one or more candidate rules within the first set of candidate rules, to generate a first set of verified rules; and operate the firewall with the first set of verified rules for the first application.

Additional aspects and examples disclosed herein are directed to a method of firewall auto-learning comprising: based at least on a first trigger event, determining a first set of restricted dependencies for a cloud service firewall to learn for a first application; during a first learning phase, learning a first set of candidate rules corresponding to at least a portion of the first set of restricted dependencies; receiving an indication of verifying, blocking, or tailoring one or more candidate rules within the first set of candidate rules, to generate a first set of verified rules; and operating the firewall with the first set of verified rules for the first application.

Additional aspects and examples disclosed herein are directed to one or more computer storage devices having computer-executable instructions stored thereon for firewall auto-learning, which, on execution by a computer, cause the computer to perform operations comprising: receiving a set of constraints for a first set of restricted dependencies, wherein receiving a set of constraints for the first set of restricted dependencies comprises receiving at least one input selected from the list consisting of: a selection from a set of preset constraints and a custom constraint; based at least on a first trigger event, determining the first set of restricted dependencies for a cloud service firewall to learn for a first application, wherein the first trigger event comprises an event selected from the list consisting of: a user input and an update to the first application, and wherein the first set of restricted dependencies comprises at least one dependency selected from the list consisting of: an application dependency and a network dependency; during a first learning phase, learning a first set of candidate rules corresponding to at least a portion of the first set of restricted dependencies: during the first learning phase, generating logs from learning the first set of candidate rules; and determining whether, from among the first set of restricted dependencies, a dependency was not exercised; based at least on determining that a dependency was not exercised, generating an alert identifying that a dependency was not exercised; presenting the logs for evaluation; receiving an indication of verifying, blocking, or tailoring one or more candidate rules within the first set of candidate rules, to generate a first set of verified rules; operating the firewall with the first set of verified rules for the first application; based at least on a second trigger event, determining a second set of restricted dependencies for the firewall to learn for the first application, wherein the second trigger event comprises an event selected from the list consisting of: a user input and an update to the first application; during a second learning phase, learning a second set of candidate rules corresponding to at least a portion of the second set of restricted dependencies; receiving an indication of verifying, blocking, or tailoring one or more candidate rules within the second set of candidate rules, to generate a second set of verified rules, the second set of verified rules different from the first set of verified rules; operating the firewall with the second set of verified rules for the first application; based at least on a third trigger event, determining a third set of restricted dependencies for the firewall to learn for a second application; during a third learning phase, learning a third set of candidate rules corresponding to at least a portion of the third set of restricted dependencies; receiving an indication of verifying, blocking, or tailoring one or more candidate rules within the third set of candidate rules, to generate a third set of verified rules; and operating the firewall with the third set of verified rules for the second application.

Alternatively, or in addition to the other examples described herein, examples include any combination of the following:
based at least on a second trigger event, determining a second set of restricted dependencies for the firewall to learn for the first application;
during a second learning phase, learning a second set of candidate rules corresponding to at least a portion of the second set of restricted dependencies;
receiving an indication of verifying, blocking, or tailoring one or more candidate rules within the second set of candidate rules, to generate a second set of verified rules, the second set of verified rules different from the first set of verified rules;
operating the firewall with the second set of verified rules for the first application;
the first trigger event comprises an event selected from the list consisting of: a user input and an update to the first application;
the second trigger event comprises an event selected from the list consisting of: a user input and an update to the first application;
based at least on a third trigger event, determining a third set of restricted dependencies for the firewall to learn for a second application;
during a third learning phase, learning a third set of candidate rules corresponding to at least a portion of the third set of restricted dependencies;
receiving an indication of verifying, blocking, or tailoring one or more candidate rules within the third set of candidate rules, to generate a third set of verified rules;
operating the firewall with the third set of verified rules for the second application;
receiving a set of constraints for the first set of restricted dependencies;
receiving a set of constraints for the first set of restricted dependencies comprises receiving at least one input selected from the list consisting of: a selection from a set of preset constraints and a custom constraint;
the first set of restricted dependencies comprises at least one dependency selected from the list consisting of: an application dependency and a network dependency;
determining whether, from among the first set of restricted dependencies, a dependency was not exercised;
based at least on determining that a dependency was not exercised, generating an alert identifying that a dependency was not exercised;
during the first learning phase, generating logs from learning the first set of candidate rules;
prior to receiving an indication of verifying, blocking, or tailoring one or more candidate rules, presenting the logs for evaluation; and
receiving instructions for the first set of candidate rules to learn and deny or to learn and allow.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 7 is a block diagram of an example computing device 700 for implementing aspects disclosed herein and is designated generally as computing device 700. Computing device 700 is but one example of a suitable computing environment and is not intended to suggest any limitation as to the scope of use or functionality of the examples disclosed herein. Neither should computing device 700 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 700 includes a bus 710 that directly or indirectly couples the following devices: computer-storage memory 712, one or more processors 714, one or more presentation components 716, I/O ports 718, I/O components 720, a power supply 722, and a network component 724. While computing device 700 is depicted as a seemingly single device, multiple computing devices 700 may work together and share the depicted device resources. For example, memory 712 may be distributed across multiple devices, and processor(s) 714 may be housed with different devices.

Bus 710 represents what may be one or more busses (such as an address bus, data bus, or a combination thereof). Although the various blocks of FIG. 7 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 7 and the references herein to a “computing device.” Memory 712 may take the form of the computer-storage media references below and operatively provide storage of computer-readable instructions, data structures, program modules and other data for the computing device 700. In some examples, memory 712 stores one or more of an operating system, a universal application platform, or other program modules and program data. Memory 712 is thus able to store and access data 712a and instructions 712b that are executable by processor 714 and configured to carry out the various operations disclosed herein.

In some examples, memory 712 includes computer-storage media in the form of volatile and/or nonvolatile memory, removable or non-removable memory, data disks in virtual environments, or a combination thereof. Memory 712 may include any quantity of memory associated with or accessible by the computing device 700. Memory 712 may be internal to the computing device 700 (as shown in FIG. 7), external to the computing device 700 (not shown), or both (not shown). Examples of memory 712 in include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by the computing device 700. Additionally, or alternatively, the memory 712 may be distributed across multiple computing devices 700, for example, in a virtualized environment in which instruction processing is carried out on multiple devices 700. For the purposes of this disclosure, “computer storage media,” “computer-storage memory,” “memory,” and “memory devices” are synonymous terms for the computer-storage memory 712, and none of these terms include carrier waves or propagating signaling.

Processor(s) 714 may include any quantity of processing units that read data from various entities, such as memory 712 or I/O components 720. Specifically, processor(s) 714 are programmed to execute computer-executable instructions for implementing aspects of the disclosure. The instructions may be performed by the processor, by multiple processors within the computing device 700, or by a processor external to the client computing device 700. In some examples, the processor(s) 714 are programmed to execute instructions such as those illustrated in the flow charts discussed below and depicted in the accompanying drawings. Moreover, in some examples, the processor(s) 714 represent an implementation of analog techniques to perform the operations described herein. For example, the operations may be performed by an analog client computing device 700 and/or a digital client computing device 700. Presentation component(s) 716 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 700, across a wired connection, or in other ways. I/O ports 718 allow computing device 700 to be logically coupled to other devices including I/O components 720, some of which may be built in. Example I/O components 720 include, for example but without limitation, a microphone, joystick, game pad, satellite dish, scanner, printer, wireless device, etc.

Computing device 700 may operate in a networked environment via network component 724 using logical connections to one or more remote computers. In some examples, network component 724 includes a network interface card and/or computer-executable instructions (e.g., a driver) for operating the network interface card. Communication between the computing device 700 and other devices may occur using any protocol or mechanism over any wired or wireless connection. In some examples, network component 724 is operable to communicate data over public, private, or hybrid (public and private) using a transfer protocol, between devices wirelessly using short range communication technologies (e.g., near-field communication (NFC), BLUETOOTH® communications, or the like), or a combination thereof. Network component 724 communicates over wireless communication link 726 and/or a wired communication link 726a to a cloud resource 728 across network 730 (which in some examples includes at least a portion of internet 164 of FIG. 1). Various different examples of communication links 726 and 726a include a wireless connection, a wired connection, and/or a dedicated link, and in some examples, at least a portion is routed through the interne.

Although described in connection with an example computing device 700, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device. via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system for permitting firewall traffic as exceptions in default traffic denial environments, the system comprising:
a processor; and
a computer-readable medium storing instructions that are operative when executed by the processor to:
based at least on a first trigger event, determine a first set of restricted dependencies for a cloud service firewall to analyze for a first application, the first set of restricted dependencies for traffic associated with the cloud service firewall;
during a first analysis phase, analyze a first set of candidate rules corresponding to at least a portion of the first set of restricted dependencies for traffic that includes a preset constraint on permitted traffic;
receive an indication of verifying, blocking, or tailoring one or more candidate rules within the first set of candidate rules, to generate a first set of verified rules; and
operate the cloud service firewall with the first set of verified rules for the first application.

2. The system of claim 1 wherein the instructions are further operative to:
based at least on a second trigger event, determine a second set of restricted dependencies for the cloud service firewall to analyze for the first application;
during a second analysis phase, analyze a second set of candidate rules corresponding to at least a portion of the second set of restricted dependencies;
receive an indication of verifying, blocking, or tailoring one or more candidate rules within the second set of candidate rules, to generate a second set of verified rules, the second set of verified rules different from the first set of verified rules; and
operate the cloud service firewall with the second set of verified rules for the first application.

3. The system of claim 2 wherein the first trigger event and the second trigger event each comprises an event selected from the list consisting of:
a user input and an update to the first application.

4. The system of claim 1 wherein the instructions are further operative to:
based at least on a third trigger event, determine a third set of restricted dependencies for the cloud service firewall to learn for a second application;
during a third analysis phase, analyze a third set of candidate rules corresponding to at least a portion of the third set of restricted dependencies;
receive an indication of verifying, blocking, or tailoring one or more candidate rules within the third set of candidate rules, to generate a third set of verified rules; and
operate the cloud service firewall with the third set of verified rules for the second application.

5. The system of claim 1 wherein the instructions are further operative to:
receive a set of constraints for the first set of restricted dependencies.

6. The system of claim 5 wherein receiving a set of constraints for the first set of restricted dependencies comprises receiving at least one input selected from the list consisting of:
a selection from a set of preset constraints and a custom constraint.

7. The system of claim 1 wherein the first set of restricted dependencies comprises at least one dependency selected from the list consisting of:
an application dependency and a network dependency.

8. The system of claim 1 wherein the instructions are further operative to:
determine whether, from among the first set of restricted dependencies, a dependency was not exercised; and
based at least on determining that a dependency was not exercised, generate an alert identifying that a dependency was not exercised.

9. The system of claim 1 wherein the instructions are further operative to:
during the first analysis phase, generate logs from analyzing the first set of candidate rules; and
prior to receiving an indication of verifying, blocking, or tailoring one or more candidate rules, present the logs for evaluation.

10. A method of permitting firewall traffic as exceptions in default traffic denial environments, the method comprising:
based at least on a first trigger event, determining a first set of restricted dependencies for a cloud service firewall to analyze for a first application;
during a first analysis phase, analyzing a first set of candidate rules corresponding to at least a portion of the first set of restricted dependencies that includes a preset constraint on permitted traffic;
receiving an indication of verifying, blocking, or tailoring one or more candidate rules within the first set of candidate rules, to generate a first set of verified rules; and
operating the cloud service firewall with the first set of verified rules for the first application.

11. The method of claim 10 further comprising:
based at least on a second trigger event, determining a second set of restricted dependencies for the cloud service firewall to analyze for the first application;
during a second analysis phase, analyzing a second set of candidate rules corresponding to at least a portion of the second set of restricted dependencies;
receiving an indication of verifying, blocking, or tailoring one or more candidate rules within the second set of candidate rules, to generate a second set of verified rules, the second set of verified rules different from the first set of verified rules; and
operating the cloud service firewall with the second set of verified rules for the first application.

12. The method of claim 11 wherein the first trigger event and the second trigger event each comprises an event selected from the list consisting of:
a user input and an update to the first application.

13. The method of claim 10 further comprising:
based at least on a third trigger event, determining a third set of restricted dependencies for the cloud service firewall to analyze for a second application;
during a third analysis phase, analyzing a third set of candidate rules corresponding to at least a portion of the third set of restricted dependencies;
receiving an indication of verifying, blocking, or tailoring one or more candidate rules within the third set of candidate rules, to generate a third set of verified rules; and
operating the cloud service firewall with the third set of verified rules for the second application.

14. The method of claim 10 further comprising:
receiving a set of constraints for the first set of restricted dependencies.

15. The method of claim 14 wherein receiving a set of constraints for the first set of restricted dependencies comprises receiving at least one input selected from the list consisting of:
a selection from a set of preset constraints and a custom constraint.

16. The method of claim 10 wherein the first set of restricted dependencies comprises at least one dependency selected from the list consisting of:
an application dependency and a network dependency.

17. The method of claim 10 further comprising:
determining whether, from among the first set of restricted dependencies, a dependency was not exercised; and
based at least on determining that a dependency was not exercised, generating an alert identifying that a dependency was not exercised.

18. The method of claim 10 further comprising:
during the first analysis phase, generating logs from analyzing the first set of candidate rules; and
prior to receiving an indication of verifying, blocking, or tailoring one or more candidate rules, presenting the logs for evaluation.

19. One or more computer storage devices having computer-executable instructions stored thereon for permitting firewall traffic as exceptions in default traffic denial environments, which, on execution by a computer, cause the computer to perform operations comprising:
receiving a set of constraints for a first set of restricted dependencies, wherein receiving a set of constraints for the first set of restricted dependencies comprises receiving at least one input selected from the list consisting of:
a selection from a set of preset constraints and a custom constraint;
based at least on a first trigger event, determining the first set of restricted dependencies for a cloud service firewall to analyze for a first application, wherein the first trigger event comprises an event selected from the list consisting of:
a user input and an update to the first application, and
wherein the first set of restricted dependencies comprises at least one dependency selected from the list consisting of:
an application dependency and a network dependency;
during a first analysis phase, analyzing a first set of candidate rules corresponding to at least a portion of the first set of restricted dependencies;
during the first analysis phase, generating logs from analyzing the first set of candidate rules; and
determining whether, from among the first set of restricted dependencies, a dependency was not exercised;
based at least on determining that a dependency was not exercised, generating an alert identifying that a dependency was not exercised;
presenting the logs for evaluation;
receiving an indication of verifying, blocking, or tailoring one or more candidate rules within the first set of candidate rules, to generate a first set of verified rules;
operating the cloud service firewall with the first set of verified rules for the first application;
based at least on a second trigger event, determining a second set of restricted dependencies for the cloud service firewall to analyze for the first application, wherein the second trigger event comprises an event selected from the list consisting of:
a user input and an update to the first application;
during a second analysis phase, analyzing a second set of candidate rules corresponding to at least a portion of the second set of restricted dependencies;
receiving an indication of verifying, blocking, or tailoring one or more candidate rules within the second set of candidate rules, to generate a second set of verified rules, the second set of verified rules different from the first set of verified rules;
operating the cloud service firewall with the second set of verified rules for the first application;
based at least on a third trigger event, determining a third set of restricted dependencies for the cloud service firewall to analyze for a second application;
during a third analysis phase, analyzing a third set of candidate rules corresponding to at least a portion of the third set of restricted dependencies;
receiving an indication of verifying, blocking, or tailoring one or more candidate rules within the third set of candidate rules, to generate a third set of verified rules; and
operating the cloud service firewall with the third set of verified rules for the second application.

20. The one or more computer storage devices of claim 19 wherein the operations further comprise:
receiving instructions for the first set of candidate rules to learn and deny or to learn and allow.
